(19) United States
(12) Patent Application Publication
(10) Pub. No.: US 2023/0138866 A1
(43) Pub. Date: May 4, 2023

(54) ENERGY STORAGE DEVICE FOR WATER ELECTROLYSIS HYDROGEN PRODUCTION COUPLED WITH LOW TEMPERATURE AND ENERGY STORAGE METHOD

(71) Applicant: HANGZHOU OXYGEN PLANT GROUP CO., LTD., Hangzhou City (CN)

(72) Inventors: Yisong HAN, Hangzhou City (CN); Fang TAN, Hangzhou City (CN); Xudong PENG, Hangzhou City (CN); Lei YAO, Hangzhou City (CN); Liangying LI, Hangzhou City (CN)

(73) Assignee: HANGZHOU OXYGEN PLANT GROUP CO., LTD., Hangzhou City (CN)

(21) Appl. No.: 18/051,033

(22) Filed: Oct. 31, 2022

(30) Foreign Application Priority Data
Nov. 2, 2021 (CN) 202111286736.6

(51) Int. Cl. C25B 15/08; C25B 1/04; C25B 1/55; C25B 9/67; C25B 15/021; C25B 5/00

(52) U.S. Cl. CPC C25B 15/083; C25B 1/04; C25B 1/55; C25B 9/67; C25B 15/021; C25B 5/00

(57) ABSTRACT

The present disclosure relates to an energy storage device for water electrolysis hydrogen production coupled with low temperature and an energy storage method, which are used for solving the problem of the contradiction between the discontinuous photoelectric resources and the continuous requirements of green hydrogen for production. The device comprises a liquid nitrogen precooling hydrogen liquefaction system, a liquid hydrogen-liquid nitrogen heat exchanging system, a cold energy storage system and a cold energy utilization system of an air separation device. According to the present disclosure, the systems are highly coupled with each other, the photoelectric renewable energy can be maximized in the form of hydrogen storage, the energy consumption cost of green hydrogen preparation and utilization can be effectively reduced while high-efficiency energy storage and peak regulation are realized, the energy saving effect is achieved, and a good popularization prospect occurs.

### TECHNICAL FIELD

The present disclosure relates to the fields of solar renewable energy power generation, green electricity water electrolysis hydrogen production, hydrogen liquefaction energy storage and hydrogen energy, in particular to an energy storage device for water electrolysis hydrogen production coupled with low temperature and an energy storage method.

### BACKGROUND

The renewable energy, represented by solar energy, is greatly influenced by natural environmental factors (season and weather), and its energy input and power output cannot achieve the precise control like fossil energy in the process of power generation. The renewable energy has the characteristics of large fluctuation, discontinuity, randomness, uncontrollability, etc., and it is difficult to directly access the power grid for utilization, resulting in large-scale light abandonment. Therefore, how to effectively inhibit the photoelectric power fluctuation and improve the photoelectric absorption capacity has become the key technical bottleneck limiting the large-scale development of photoelectricity. As an energy buffer means, the energy storage system can effectively inhibit the photoelectric power fluctuation, reduce the light abandonment and electricity abandonment, and play an increasingly important role in promoting the rational utilization of renewable energy.

Hydrogen energy is excellent in energy density, energy utilization efficiency and cleanliness. The electric energy, nuclear energy, solar energy, wind energy and water energy can be converted into hydrogen energy for storage, transportation or direct use, which is referred to as the best carbon-neutral energy carrier and plays a key role in the process of “decarbonization”. Hydrogen energy can be prepared by natural gas or fossil fuel reforming, industrial by-product hydrogen purification, renewable electricity electrolysis and other large-scale manners. The “green hydrogen” produced by using renewable energy such as solar energy to generate electricity and electrolyze is the “ultimate goal” of future energy sources because there is no or little carbon emission in the preparation process. As a carrier of hydrogen energy, the use of the hydrogen for concentrated treatment of renewable resources has been popularized all over the world, which is conducive to the joint development of renewable resources and hydrogen energy and has a broad market prospect. At present, hydrogen energy is mostly used in traditional industrial fields, such as oil refining, ammonia synthesis, methanol production, etc. However, the unstable flow rate of raw material hydrogen prepared by electricity electrolysis using renewable energy such as solar energy will directly have a great impact on downstream processes. Therefore, how to prepare continuously supplied “green hydrogen” from renewable energy sources such as discontinuous and volatile solar energy is a hot and difficult point in current research.

In order to ensure the continuous supply of “green hydrogen”, when the renewable energy power generation system has sufficient electricity, that is, sufficient sunshine, the green electricity generated in this stage can produce enough hydrogen by water electrolysis hydrogen production, which can be used as raw gas to be supplied to downstream factories and enterprises. At the same time, some surplus hydrogen is also available. In order to make full use of the surplus hydrogen, the surplus hydrogen can be stored as energy for further energy supply in the energy shortage stage. At present, hydrogen storage technologies mainly comprise high-pressure gaseous hydrogen storage, low-temperature liquid hydrogen storage, organic liquid hydrogen storage and solid hydrogen storage. Because of its advantages of storage density and high storage and transportation efficiency, liquid hydrogen energy storage has become a more suitable form of hydrogen energy storage for large-scale and long-distance storage and transportation requirements. The surplus hydrogen of hydrogen production from photoelectric green electrolysis is liquefied by the hydrogen liquefaction system, and then is sent to the liquid hydrogen storage tank for storage. When the renewable energy power generation system is short of electricity due to environmental changes, such as the solar power generation system cannot provide the electricity needed for green electrolysis hydrogen production at night, in order to continuously provide stable raw hydrogen for downstream factories, it is only necessary to vaporize the liquid hydrogen in the storage tank into hydrogen and supply the hydrogen to the downstream process pipe network. However, due to the extremely low boiling point (20K) of hydrogen in the hydrogen liquefaction process, the energy consumption caused by liquefaction and refrigeration is high. How to reduce the energy consumption in the industrial large-scale hydrogen storage application becomes the key to hydrogen storage, which is also the key for “green hydrogen” to promote the rational utilization and development of renewable resources such as solar energy.

### SUMMARY

The technical problem to be solved by the present disclosure is to provide an energy storage device for water electrolysis hydrogen production coupled with low temperature and an energy storage method, which are used for solving the problem of the contradiction between the discontinuous photoelectric resources and the continuous requirements of hydrogen for production. The photoelectric renewable energy can be maximized in the form of liquid hydrogen storage, and the energy consumption cost of green hydrogen preparation and utilization can be effectively reduced while high-efficiency energy storage and peak regulation are realized, so as to achieve the energy saving effect. In order to achieve the above purpose, the present disclosure uses the following technologies: an energy storage device for water electrolysis hydrogen production coupled with low temperature, wherein the device comprises a liquid nitrogen precooling hydrogen liquefaction system, a liquid hydrogen-liquid nitrogen heat exchanging system, a cold energy storage system and a cold energy utilization system of an air separation device; the liquid nitrogen precooling hydrogen liquefaction system comprises a liquid nitrogen input system, a nitrogen output system, a liquid hydrogen output system and a hydrogen liquefaction system, all of which are connected by pipelines and are controlled by valves; the liquid hydrogen-liquid nitrogen heat exchanging system comprises a liquid hydrogen storage tank, a liquid hydrogen pump, a liquid hydrogen-liquid nitrogen heat exchanger and a liquid nitrogen storage tank, all of which are connected by pipelines and are controlled by valves for vaporizing liquid hydrogen and liquefying nitrogen, wherein a liquid hydrogen input end of the liquid hydrogen storage tank is connected to a liquid hydrogen output system of the liquid nitrogen precooling hydrogen liquefaction system, a liquid hydrogen input end of the liquid hydrogen pump is connected to the liquid hydrogen output end of the liquid hydrogen storage tank, the liquid hydrogen input end of the liquid hydrogen-liquid nitrogen heat exchanger is connected to the liquid hydrogen output end of the liquid hydrogen pump, the nitrogen input end of the liquid hydrogen-liquid nitrogen heat exchanger is connected to a nitrogen output end of the nitrogen output system of the air separation device product of the cold energy utilization system of the air separation device, the liquid nitrogen output end of the liquid hydrogen-liquid nitrogen heat exchanger is connected to the liquid nitrogen input end of the liquid nitrogen storage tank, and the liquid nitrogen output end of the liquid nitrogen storage tank is connected to the input end of the liquid nitrogen input system of the liquid nitrogen precooling hydrogen liquefaction system.

Preferably, the cold energy storage system comprises a hydrogen-refrigerating medium heat exchanger, a refrigerating medium pump, a refrigerating medium-cold energy storage heat exchanger, a refrigerating medium storage tank, and a cold energy storage tank, all of which are connected by pipelines and are controlled by valves to reheat hydrogen and store cold energy, wherein the hydrogen input end of the hydrogen-refrigerating medium heat exchanger is connected to the hydrogen output end of the liquid hydrogen-liquid nitrogen heat exchanger, the refrigerating medium output end of the hydrogen-refrigerating medium heat exchanger is connected to the refrigerating medium input end of the refrigerating medium pump, the refrigerating medium output end of the refrigerating medium pump is connected to the refrigerating medium input end of the refrigerating medium-cold energy storage heat exchanger, the refrigerating medium output end of the refrigerating medium-cold energy storage heat exchanger is connected to the refrigerating medium input end of the hydrogen-refrigerating medium heat exchanger, the water output end of the refrigerating medium-cold energy storage heat exchanger is connected to the input end of the cold energy storage tank, and the refrigerating medium storage tank is connected to the refrigerating medium input end of the refrigerating medium pump by pipelines and valves.

Preferably, the cold energy utilization system of the air separation device comprises a circulating water system, a water cooling tower, a nitrogen output system of an air separation device product, and a chilled water input system of an air separation device, all of which are connected by pipelines and are controlled by valves, the output end of the circulating water system is connected to the water input end of the refrigerating medium-cold energy storage heat exchanger, the output end of the cold energy storage tank is connected to the upper input end of the water cooling tower, the output end of the nitrogen output system is connected to the lower input end of the water cooling tower, and the bottom output end of the water cooling tower is connected to the input end of the chilled water input system of the air separation device.

Preferably, the liquid hydrogen-liquid nitrogen heat exchanger, the hydrogen-refrigerating medium heat exchanger and the refrigerating medium-cold energy storage heat exchanger are all coiled tube heat exchangers or plate heat exchangers.

Preferably, the water cooling tower is a packed tower.

An energy storage method applied to the energy storage device described above comprises the following steps: Step 1: when photoelectric green water electrolysis hydrogen production is excessive, the excessive hydrogen is capable of being liquefied by a hydrogen liquefaction system, wherein liquid nitrogen is used as a precooling cold source for hydrogen liquefaction, the liquefied liquid hydrogen is sent into a liquid hydrogen storage tank for storage, the nitrogen which is vaporized and reheated to normal temperature enters the lower part of the water cooling tower through a pipeline from a nitrogen output system, and then is sprayed after low-temperature water from the cold energy storage tank enters the upper part of the water cooling tower, and the low-temperature water is further cooled, which is beneficial to the subsequent process of the air separation device and saves the energy consumption of the air separation device;

Step 2, when a renewable energy power generation system such as photoelectricity is short of green water electrolysis hydrogen production due to environmental changes, such as sunshine weakening, the liquid hydrogen stored in the liquid hydrogen storage tank is pressurized via a liquid hydrogen pump, then enters a liquid hydrogen-liquid nitrogen heat exchanger to be vaporized and reheated, and then enters a hydrogen-refrigerating medium heat exchanger to be reheated to obtain normal-temperature hydrogen for supplementing the shortage of green water electrolysis hydrogen production. At the same time, the normal-temperature nitrogen of the product nitrogen output system enters the liquid hydrogen-liquid nitrogen heat exchanger to provide a heat source for vaporizing and reheating liquid hydrogen, and enters the liquid nitrogen storage tank after being liquefied and condensed into liquid nitrogen, and is used as a partial supplement to the precooling of liquid nitrogen during hydrogen liquefaction. At the same time, the refrigerating medium enters the hydrogen-refrigerating medium heat exchanger to provide a heat source for reheating hydrogen, and enters the refrigerating medium-cold energy storage heat exchanger after being pressurized via a refrigerating medium pump after being cooled, so as to cool the normal-temperature water from the circulating water system, the normal-temperature water exits the refrigerating medium-cold energy storage heat exchanger and enters the cold energy storage tank after being cooled into low-temperature water, the low-temperature water of the cold energy storage tank enters the upper part of the water cooling tower through pipelines and valves to be sprayed to further reduce the water temperature.

Preferably, the refrigerating medium is an inorganic or organic compound or the mixed solution or the aqueous solution thereof. Furthermore, the refrigerating medium is mainly preferably an organic compound aqueous solution, such as ethylene glycol aqueous solution, propylene glycol aqueous solution, methanol, methanol aqueous solution or ethanol aqueous solution.

Preferably, the water cooling tower is filled with packing.

The present disclosure has the following beneficial effects.

The present disclosure utilizes the photoelectric green water electrolysis hydrogen production and low-temperature technology to couple energy storage. When photoelectric renewable energy is sufficient, surplus hydrogen produced by green water electrolysis hydrogen production liquefies and stores hydrogen through the liquid nitrogen precooling hydrogen liquefaction system. When the electricity generation of photovoltaic renewable energy is reduced due to environmental changes, resulting in insufficient green water electrolysis hydrogen production, the stored liquid hydrogen is vaporized and reheated by the liquid hydrogen-liquid nitrogen heat exchanging system and the cold energy storage system and then is supplied to the downstream process pipe network. At the same time, the liquid nitrogen obtained by low-temperature heat exchange can provide partial precooling cold source for the hydrogen liquefaction system. The cold energy stored by the cold energy storage system can be used by the cold energy utilization system of the air separation device. The present disclosure solves the problem of the contradiction between the discontinuous photoelectric resources and the continuous requirements of green hydrogen for production. The photoelectric renewable energy can be maximized in the form of hydrogen storage, the energy consumption cost of green hydrogen preparation and utilization can be effectively reduced while high-efficiency energy storage and peak regulation are realized, the energy saving effect is achieved, and a good popularization prospect occurs.

### BRIEF DESCRIPTION OF THE DRAWINGS

FIG. 1 is a schematic diagram of the present disclosure.

### DETAILED DESCRIPTION OF THE EMBODIMENTS

In order to make the technical problems, technical schemes and beneficial effects to be solved by the present disclosure clearer, the present disclosure will be further explained in detail with reference to the drawings and specific embodiments hereinafter. It should be pointed out that for those skilled in the art, several improvements and modifications can be made to the present disclosure without departing from the principle of the present disclosure, and these improvements and modifications also fall within the scope of protection of the claims of the present disclosure.

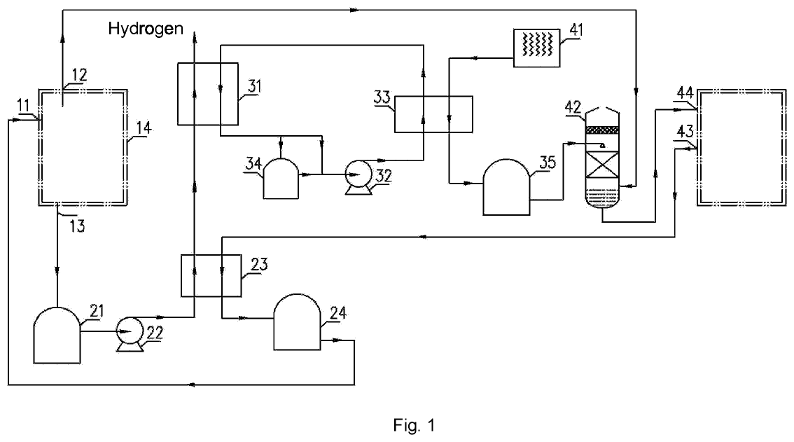

The present disclosure will be described in detail with reference to the attached drawings. As shown in FIG. 1, an energy storage device for water electrolysis hydrogen production coupled with low temperature is provided. The device comprises a liquid nitrogen precooling hydrogen liquefaction system, a liquid hydrogen-liquid nitrogen heat exchanging system, a cold energy storage system and a cold energy utilization system of an air separation device. The liquid nitrogen precooling hydrogen liquefaction system comprises a liquid nitrogen input system 11, a nitrogen output system 12, a liquid hydrogen output system 13 and a hydrogen liquefaction system 14, all of which are connected by pipelines and are controlled by valves. The liquid hydrogen-liquid nitrogen heat exchanging system comprises a liquid hydrogen storage tank 21, a liquid hydrogen pump 22, a liquid hydrogen-liquid nitrogen heat exchanger 23 and a liquid nitrogen storage tank 24, all of which are connected by pipelines and are controlled by valves for vaporizing liquid hydrogen and liquefying nitrogen, wherein a liquid hydrogen input end of the liquid hydrogen storage tank 21 is connected to a liquid hydrogen output system 13 of the liquid nitrogen precooling hydrogen liquefaction system. A liquid hydrogen input end of the liquid hydrogen pump 22 is connected to the liquid hydrogen output end of the liquid hydrogen storage tank 21. The liquid hydrogen input end of the liquid hydrogen-liquid nitrogen heat exchanger 23 is connected to the liquid hydrogen output end of the liquid hydrogen pump 22. The nitrogen input end of the liquid hydrogen-liquid nitrogen heat exchanger 23 is connected to a nitrogen output end of the nitrogen output system 43 of the air separation device product of the cold energy utilization system of the air separation device. The liquid nitrogen output end of the liquid hydrogen-liquid nitrogen heat exchanger 23 is connected to the liquid nitrogen input end of the liquid nitrogen storage tank 24. The liquid nitrogen output end of the liquid nitrogen storage tank 24 is connected to the input end of the liquid nitrogen input system 11 of the liquid nitrogen precooling hydrogen liquefaction system. The cold energy storage system comprises a hydrogen-refrigerating medium heat exchanger 31, a refrigerating medium pump 32, a refrigerating medium-cold energy storage heat exchanger 33, a refrigerating medium storage tank 34, and a cold energy storage tank 35, all of which are connected by pipelines and are controlled by valves to reheat hydrogen and store cold energy, wherein the hydrogen input end of the hydrogen-refrigerating medium heat exchanger 31 is connected to the hydrogen output end of the liquid hydrogen-liquid nitrogen heat exchanger 23. The refrigerating medium output end of the hydrogen-refrigerating medium heat exchanger 31 is connected to the refrigerating medium input end of the refrigerating medium pump 32. The refrigerating medium output end of the refrigerating medium pump 32 is connected to the refrigerating medium input end of the refrigerating medium-cold energy storage heat exchanger 33. The refrigerating medium output end of the refrigerating medium-cold energy storage heat exchanger 33 is connected to the refrigerating medium input end of the hydrogen-refrigerating medium heat exchanger 31. The water output end of the refrigerating medium-cold energy storage heat exchanger 33 is connected to the input end of the cold energy storage tank 35. The refrigerating medium storage tank 34 is connected to the refrigerating medium input end of the refrigerating medium pump 32 by pipelines and valves. The cold energy utilization system of the air separation device comprises a circulating water system 41, a water cooling tower 42, a nitrogen output system 43 of an air separation device product, and a chilled water input system 44 of an air separation device, all of which are connected by pipelines and are controlled by valves. The output end of the circulating water system 41 is connected to the water input end of the refrigerating medium-cold energy storage heat exchanger 33. The output end of the cold energy storage tank 35 is connected to the upper input end of the water cooling tower 42. The output end of the nitrogen output system 12 is connected to the lower input end of the water cooling tower 42. The bottom output end of the water cooling tower 42 is connected to the input end of the chilled water input system 44 of the air separation device. The liquid hydrogen-liquid nitrogen heat exchanger 23, the hydrogen-refrigerating medium heat exchanger 31 and the refrigerating medium-cold energy storage heat exchanger 33 are all coiled tube heat exchangers or plate heat exchangers. The water cooling tower 42 is a packed tower.

An energy storage method applied to the energy storage device described above comprises the following steps: Step 1: when photoelectric green water electrolysis hydrogen production is excessive, the excessive hydrogen is capable of being liquefied by a hydrogen liquefaction system, wherein liquid nitrogen is used as a precooling cold source for hydrogen liquefaction. The liquefied liquid hydrogen is sent into a liquid hydrogen storage tank 21 for storage. The nitrogen which is vaporized and reheated to normal temperature enters the lower part of the water cooling tower 42 through a pipeline from a nitrogen output system 12, and then is sprayed after low-temperature water from the cold energy storage tank 35 enters the upper part of the water cooling tower 42. The low-temperature water is further cooled, which is beneficial to the subsequent process of the air separation device and saves the energy consumption of the air separation device.

Step 2, when a renewable energy power generation system such as photoelectricity is short of green water electrolysis hydrogen production due to environmental changes, such as sunshine weakening, the liquid hydrogen stored in the liquid hydrogen storage tank 21 is pressurized via a liquid hydrogen pump 22, then enters a liquid hydrogen-liquid nitrogen heat exchanger 23 to be vaporized and reheated, and then enters a hydrogen-refrigerating medium heat exchanger 31 to be reheated to obtain normal-temperature hydrogen for supplementing the shortage of green water electrolysis hydrogen production. At the same time, the normal-temperature nitrogen of the product nitrogen output system 43 enters the liquid hydrogen-liquid nitrogen heat exchanger 23 to provide a heat source for vaporizing and reheating liquid hydrogen, and enters the liquid nitrogen storage tank 24 after being liquefied and condensed into liquid nitrogen, and is used as a partial supplement to the precooling of liquid nitrogen during hydrogen liquefaction. At the same time, the refrigerating medium enters the hydrogen-refrigerating medium heat exchanger 31 to provide a heat source for reheating hydrogen, and enters the refrigerating medium-cold energy storage heat exchanger 33 after being pressurized via a refrigerating medium pump 32 after being cooled, so as to cool the normal-temperature water from the circulating water system 41. The normal-temperature water exits the refrigerating medium-cold energy storage heat exchanger 33 and enters the cold energy storage tank 35 after being cooled into low-temperature water. The low-temperature water of the cold energy storage tank 35 enters the upper part of the water cooling tower 42 through pipelines and valves to be sprayed to further reduce the water temperature.

The refrigerating medium is an inorganic or organic compound or the mixed solution or the aqueous solution thereof. Furthermore, the refrigerating medium is mainly preferably an organic compound aqueous solution, such as ethylene glycol aqueous solution, propylene glycol aqueous solution, methanol, methanol aqueous solution or ethanol aqueous solution. The water cooling tower 42 is filled with packing.

When photoelectric green water electrolysis hydrogen production is excessive, the excessive hydrogen is liquefied by a hydrogen liquefaction system 14. The hydrogen liquefaction system 14 generally uses the liquid nitrogen precooling Claude hydrogen circulation hydrogen liquefaction system or Brayton helium circulation hydrogen liquefaction system widely used in the market. Liquid nitrogen which is a precooling cold source for hydrogen liquefaction can be input into the hydrogen liquefaction system 14 from the liquid nitrogen storage tank 24 through the liquid nitrogen input system 11. The vaporized nitrogen enters the lower part of the water cooling tower 42 through the pipeline via the nitrogen output system 12. The nitrogen is sprayed after low-temperature water from the cold energy storage tank 35 enters the upper part of the water cooling tower 42. The low-temperature water is further cooled. As widely known to the air separation device, the reduction of the temperature of the low-temperature water in the water cooling tower of the precooling system of the air separation device within a reasonable range is beneficial to saving the overall energy consumption of the air separation device and reducing the unit consumption of the air separation device product.

When a renewable energy power generation system such as photoelectricity is short of green water electrolysis hydrogen production due to environmental changes, such as sunshine weakening, the liquid hydrogen stored in the liquid hydrogen storage tank 21 is pressurized to 1.6 MPa via a liquid hydrogen pump 22, and then enters a liquid hydrogen-liquid nitrogen heat exchanger 23. At the same time, the nitrogen with a temperature of about 25° C. from the nitrogen output system 43 of the air separation device enters the liquid hydrogen-liquid nitrogen heat exchanger 23 to provide a heat source for vaporizing and reheating liquid hydrogen, and enters the liquid nitrogen storage tank 24 after being liquefied and condensed into liquid nitrogen, and is used as a partial supplement to the precooling of liquid nitrogen during hydrogen liquefaction. The supplement rate can be up to about 60%. The temperature of the hydrogen vaporized and reheated from the liquid hydrogen-liquid nitrogen heat exchanger 23 is still very low, generally around −100° C. The hydrogen needs to enter a hydrogen-refrigerating medium heat exchanger 31 to be reheated again to obtain normal-temperature hydrogen for supplementing the shortage of green water electrolysis hydrogen production. At the same time, the refrigerating medium, such as ethylene glycol aqueous solution, enters the hydrogen-refrigerating medium heat exchanger 31 to provide a heat source for reheating hydrogen, and enters the refrigerating medium-cold energy storage heat exchanger 33 after being boosted to about 0.1-0.3 MPa via a refrigerating medium pump 32 after being cooled to about 0° C., so as to cool the normal-temperature water with a temperature of 30° C. from the circulating water system 41. After being cooled to about 20° C., the normal-temperature water becomes low-temperature water. The low-temperature water exits the refrigerating medium-cold energy storage heat exchanger 33 and enters the cold energy storage tank 35 for storage. The low-temperature water of the cold energy storage tank 35 can continuously enter the upper part of the water cooling tower 42 through pipelines and valves to be sprayed, thus further reducing the temperature of the low-temperature water into chilled water.

1. An energy storage device for water electrolysis hydrogen production coupled with low temperature, wherein the device comprises a liquid nitrogen precooling hydrogen liquefaction system, a liquid hydrogen-liquid nitrogen heat exchanging system, a cold energy storage system and a cold energy utilization system of an air separation device; the liquid nitrogen precooling hydrogen liquefaction system comprises a liquid nitrogen input system, a nitrogen output system, a liquid hydrogen output system and a hydrogen liquefaction system, all of which are connected by pipelines and are controlled by valves; the liquid hydrogen-liquid nitrogen heat exchanging system comprises a liquid hydrogen storage tank, a liquid hydrogen pump, a liquid hydrogen-liquid nitrogen heat exchanger and a liquid nitrogen storage tank, all of which are connected by pipelines and are controlled by valves for vaporizing liquid hydrogen and liquefying nitrogen, wherein a liquid hydrogen input end of the liquid hydrogen storage tank is connected to a liquid hydrogen output system of the liquid nitrogen precooling hydrogen liquefaction system, a liquid hydrogen input end of the liquid hydrogen pump is connected to the liquid hydrogen output end of the liquid hydrogen storage tank, the liquid hydrogen input end of the liquid hydrogen-liquid nitrogen heat exchanger is connected to the liquid hydrogen output end of the liquid hydrogen pump, the nitrogen input end of the liquid hydrogen-liquid nitrogen heat exchanger is connected to a nitrogen output end of the nitrogen output system of the air separation device product of the cold energy utilization system of the air separation device, the liquid nitrogen output end of the liquid hydrogen-liquid nitrogen heat exchanger is connected to the liquid nitrogen input end of the liquid nitrogen storage tank, and the liquid nitrogen output end of the liquid nitrogen storage tank is connected to the input end of the liquid nitrogen input system of the liquid nitrogen precooling hydrogen liquefaction system.

2. The energy storage device for water electrolysis hydrogen production coupled with low temperature according to claim 1, wherein the cold energy storage system comprises a hydrogen-refrigerating medium heat exchanger, a refrigerating medium pump, a refrigerating medium-cold energy storage heat exchanger, a refrigerating medium storage tank, and a cold energy storage tank, all of which are connected by pipelines and are controlled by valves to reheat hydrogen and store cold energy, wherein the hydrogen input end of the hydrogen-refrigerating medium heat exchanger is connected to the hydrogen output end of the liquid hydrogen-liquid nitrogen heat exchanger, the refrigerating medium output end of the hydrogen-refrigerating medium heat exchanger is connected to the refrigerating medium input end of the refrigerating medium pump, the refrigerating medium output end of the refrigerating medium pump is connected to the refrigerating medium input end of the refrigerating medium-cold energy storage heat exchanger, the refrigerating medium output end of the refrigerating medium-cold energy storage heat exchanger is connected to the refrigerating medium input end of the hydrogen-refrigerating medium heat exchanger, the water output end of the refrigerating medium-cold energy storage heat exchanger is connected to the input end of the cold energy storage tank, and the refrigerating medium storage tank is connected to the refrigerating medium input end of the refrigerating medium pump by pipelines and valves.

3. The energy storage device for water electrolysis hydrogen production coupled with low temperature according to claim 2, wherein the cold energy utilization system of the air separation device comprises a circulating water system, a water cooling tower, a nitrogen output system of an air separation device product, and a chilled water input system of an air separation device, all of which are connected by pipelines and are controlled by valves, the output end of the circulating water system is connected to the water input end of the refrigerating medium-cold energy storage heat exchanger, the output end of the cold energy storage tank is connected to the upper input end of the water cooling tower, the output end of the nitrogen output system is connected to the lower input end of the water cooling tower, and the bottom output end of the water cooling tower is connected to the input end of the chilled water input system of the air separation device.

4. The energy storage device for water electrolysis hydrogen production coupled with low temperature according to claim 3, wherein the liquid hydrogen-liquid nitrogen heat exchanger, the hydrogen-refrigerating medium heat exchanger and the refrigerating medium-cold energy storage heat exchanger are all coiled tube heat exchangers or plate heat exchangers.

5. The energy storage device for water electrolysis hydrogen production coupled with low temperature according to claim 3, wherein the water cooling tower is a packed tower.

6. An energy storage method applied to the energy storage device according to claim 1 comprising the following steps:
Step 1: when photoelectric green water electrolysis hydrogen production is excessive, the excessive hydrogen is capable of being liquefied by a hydrogen liquefaction system, wherein liquid nitrogen is used as a precooling cold source for hydrogen liquefaction, the liquefied liquid hydrogen is sent into a liquid hydrogen storage tank for storage, the nitrogen which is vaporized and reheated to normal temperature enters the lower part of the water cooling tower through a pipeline from a nitrogen output system, and then is sprayed after low-temperature water from the cold energy storage tank enters the upper part of the water cooling tower, and the low-temperature water is further cooled, which is beneficial to the subsequent process of the air separation device and saves the energy consumption of the air separation device;
Step 2, when a renewable energy power generation system is short of green water electrolysis hydrogen production due to environmental changes, such as sunshine weakening, the liquid hydrogen stored in the liquid hydrogen storage tank is pressurized via a liquid hydrogen pump, then enters a liquid hydrogen-liquid nitrogen heat exchanger to be vaporized and reheated, and then enters a hydrogen-refrigerating medium heat exchanger to be reheated to obtain normal-temperature hydrogen for supplementing the shortage of green water electrolysis hydrogen production; at the same time, the normal-temperature nitrogen of the product nitrogen output system enters the liquid hydrogen-liquid nitrogen heat exchanger to provide a heat source for vaporizing and reheating liquid hydrogen, and enters the liquid nitrogen storage tank after being liquefied and condensed into liquid nitrogen, and is used as a partial supplement to the precooling of liquid nitrogen during hydrogen liquefaction; at the same time, the refrigerating medium enters the hydrogen-refrigerating medium heat exchanger to provide a heat source for reheating hydrogen, and enters the refrigerating medium-cold energy storage heat exchanger after being pressurized via a refrigerating medium pump after being cooled, so as to cool the normal-temperature water from the circulating water system, the normal-temperature water exits the refrigerating medium-cold energy storage heat exchanger and enters the cold energy storage tank after being cooled into low-temperature water, the low-temperature water of the cold energy storage tank enters the upper part of the water cooling tower through pipelines and valves to be sprayed to further reduce the water temperature.

7. The energy storage method according to claim 6, wherein the refrigerating medium is an inorganic or organic compound or the mixed solution or the aqueous solution thereof.

8. The energy storage method according to claim 6, wherein the water cooling tower is filled with packing.
